(19) United States
(12) Patent Application Publication
(10) Pub. No.: US 2014/0214702 A1
(43) Pub. Date: Jul. 31, 2014

(54) Methods And Systems For Notifying A Creditor That A Pre-Bankruptcy Period Has Commenced For A Debtor

(71) Applicant: Gary W. Becker, Minnetonka, MN (US)

(72) Inventor: Gary W. Becker, Minnetonka, MN (US)

(21) Appl. No.: 14/164,847

(22) Filed: Jan. 27, 2014

Related U.S. Application Data
(60) Provisional application No. 61/756,880, filed on Jan. 25, 2013.

(51) Int. Cl. G06Q 50/18; G06Q 40/00

(52) U.S. Cl. CPC G06Q 50/18; G06Q 40/00
USPC 705/311

(57) ABSTRACT

Methods and systems for notifying a creditor that a pre-bankruptcy period has commenced for a debtor are disclosed. In some embodiments, the methods include the following: detecting and validating an authorized attorney; capturing debtor data for a debtor and storing the debtor data in a debtor record in a master debtor database; generating a unique identifying code for the debtor and associating the unique identifying code with the debtor record of the debtor; providing the unique identifying code to the debtor; entering the unique identifying code via a user interface to access a master creditor database residing on the central server; searching the master creditor database for data related to a creditor of the debtor; retrieving contact information of the creditor; entering data related to the creditor of the debtor into the master creditor database; and notifying the creditor that the debtor is in a pre-bankruptcy period.

### CROSS REFERENCE TO RELATED APPLICATION(S)

This application claims the benefit of U.S. Provisional Application No. 61/756,880, filed Jan. 25, 2013, which is incorporated by reference as if disclosed herein in its entirety.

### BACKGROUND

If an individual (“debtor”) is contemplating bankruptcy, the individual typically seeks the advice of a specialist attorney for representation in a bankruptcy proceeding. Because bankruptcy attorneys must typically be fully paid in advance of the actual bankruptcy filing, and because individuals seeking bankruptcy relief often have limited financial resources at any given time, these fees are often paid through a series of regular or irregular installments, very often over a period of several months. During this period, known generally as “pre-bankruptcy,” the debtor, while not yet afforded the relief of bankruptcy protection, does have legal representation. When an individual informs a creditor that he has legal representation, collection efforts directed at the debtor must cease, unless the debtor's lawyer authorizes direct contact with his client.

In the absence of direct communication from the debtor, creditors are unaware of the debtor's claim of legal representation. Further, in the absence of direct communication from the attorney, creditors have no mechanism to verify the debtor's assertion of legal representation. Often, debtors provide incomplete information concerning the name and business address of their attorney.

### SUMMARY

Aspects of the disclosed subject matter include methods and systems for the interchange of pre-bankruptcy notifications between pending bankrupts and affected creditors. Some embodiments of the disclosed subject matter include a data processor at a central location includes a central processing unit, a token-generating component to generate access keys, a receiving component to receive a list of creditors and account details from a creditor, an importer to write the creditor list to a central database, a transmitting component to send cease notices to creditors, and a second receiving component to receive receipt confirmations to delivered cease notices.

Aspects of the disclosed subject matter relate generally to the collection, validation, and submission of notifications of a pending bankruptcy filing and ad hoc verifications of an individual's status as a pending bankrupt. Some embodiments of the disclosed subject matter relate to methods and apparatus for the identification by an attorney of an individual's bona fide status as a pending bankrupt, the electronic collection of a list of creditors to the pending bankrupt, the distribution of notifications to those creditors of the individual's pending bankruptcy, and the verification of this information to additional parties authorized by the debtor.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic diagram of methods and systems according to some embodiments of the disclosed subject matter; and

FIGS. 2A and 2B are charts of a method according to some embodiments of the disclosed subject matter.

### DETAILED DESCRIPTION

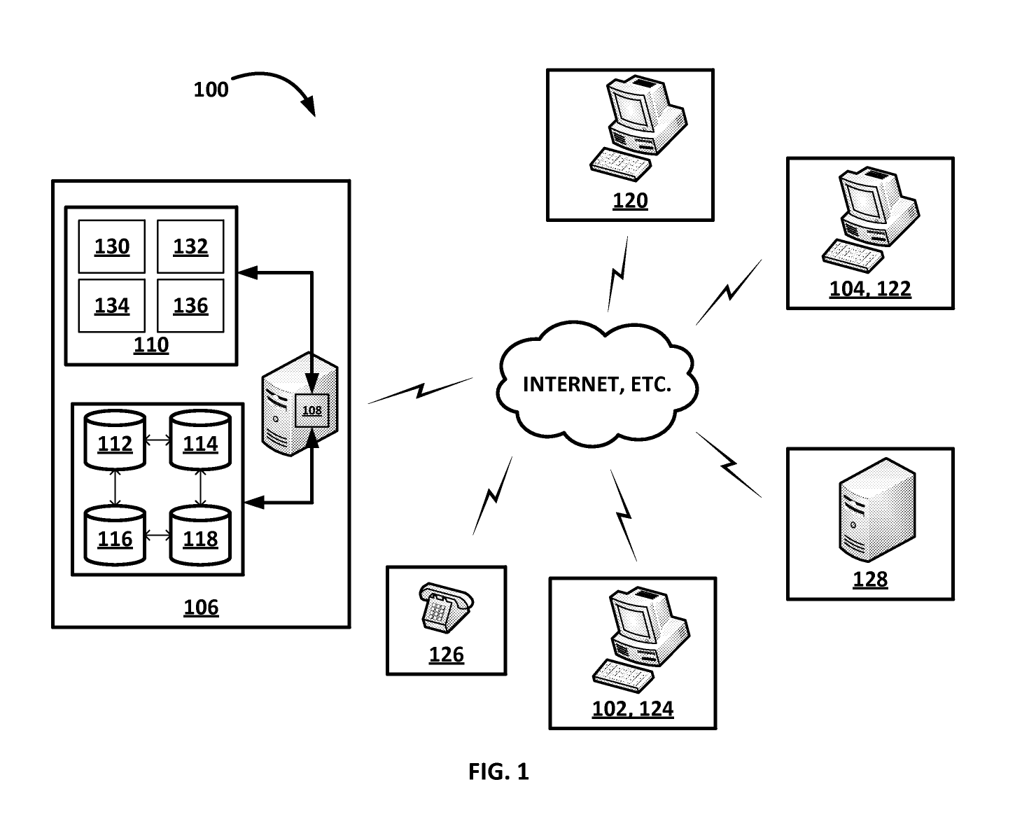

Referring now to FIG. 1, aspects of the disclosed subject matter include a system 100 for notifying a creditor 102 that a pre-bankruptcy period has commenced for a debtor 104. In some embodiments, system 100 includes a central server 106 including a central processing unit 108, application modules 110, a jurisdictional business rules and response formats database 112, a master creditor database 114, a master attorney database 116, and a master debtor database 118. In some embodiments, central server 106 is part of a cloud based system, or is formed using multiple systems. In some embodiments, central server 106 is distributed between many different systems and the master databases are further distributed rather than stored on a single server. Central processing unit 108 is typically configured to store and process data according to particular instructions included in application modules 110.

In some embodiments, system 100 includes an authorized attorney web client 120, a debtor web client 122, at least one of a creditor web client 124, creditor phone client 126, and creditor server 128, all of which are in communication with central server 106.

In some embodiments, application modules 110 include a debtor identifying code module 130, a creditor data module 132, a creditor notification module 134, and a creditor access module 136. Application modules 110 cooperate to create a unique identifying code for a debtor, identify a creditor of the debtor, and notify the creditor of the debtor that the debtor is in a pre-bankruptcy period.

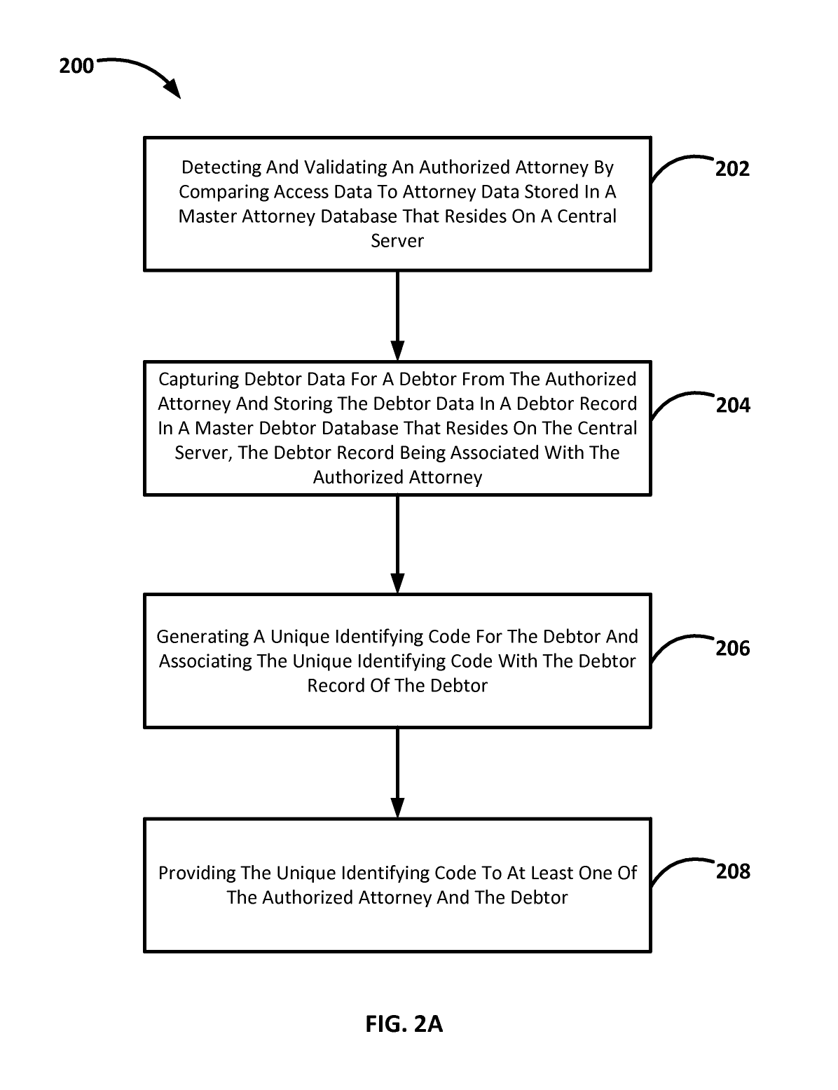

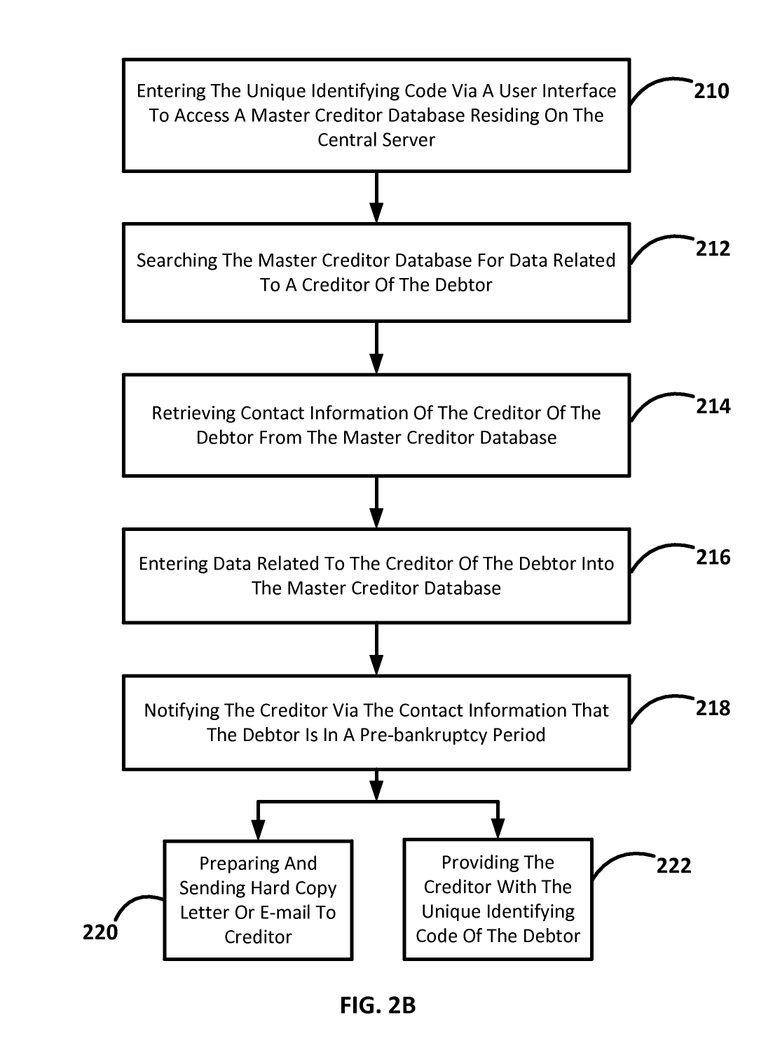

Referring now to FIGS. 2A and 2B, and specifically to FIG. 2A, some embodiments include a method 200 for notifying a creditor that a pre-bankruptcy period has commenced for a debtor. At 202, an authorized attorney is detected and/or validated by comparing access data to attorney data stored in a master attorney database that resides on a central server. The access data includes at least one of user credentials, an access method, an originating network location, and other methods of user identification and validation that are known to those skilled in the art. At 204, the authorized attorney or agent of the authorized attorney enters debtor data for a client debtor, i.e., a client that has retained the services of the authorized attorney in anticipation of filing a claim for bankruptcy protection, and the debtor data is stored in a debtor record in a master debtor database that resides on the central server. Debtor data includes general identifying information for the debtor, contact information for the debtor, and the electronic mail address for the debtor. The debtor record is associated with the authorized attorney. At 206, a unique identifying code, which is associated with the debtor record of the debtor, is generated for the debtor. The unique identifying code is generated by any of a variety of methods known to those skilled in the art. The unique identifying code is unique to the relationship between the debtor and the authorized attorney. At 208, the unique identifying code is provided to at least one of the authorized attorney and the debtor. In some embodiments, the unique identifying code is displayed to the authorized attorney who later provides it to his/her client debtor for future use. In some embodiments, the unique identifying code and further instructions are provided directly to the debtor via electronic email or other means.

Referring now to FIG. 2B, in some embodiments, method 200 includes additional steps for creating a list of creditors to whom an individual owes debts, e.g., entering, obtaining, and modifying creditor data. At 210, the unique identifying code is entered via a user interface to validate the user and allow access a master creditor database residing on the central server. In some embodiments of the process, this validation is further supplemented by prompting the user to provide personal details, e.g., physical mailing address and former or alternate names, which are verified against the same details submitted by the user's authorized attorney. At 212, the master creditor database is searched for data related to a creditor of the debtor. At 214, contact information of the creditor of the debtor is retrieved from the master creditor database. At 216, data related to the creditor of the debtor, e.g., a mailing address, an e-mail address, the debtor's account number of the creditor, etc., is obtained and entered into the master creditor database and/or debtor record in the master debtor database.

Alternatively, in some embodiments of method 200, the user/debtor is first prompted through a process to capture the details of creditors to whom they owe funds. First, the user enters the name of a creditor. Then, the method/process returns to step 212 and searches the master creditor database for creditors based on the name provided and presents a list of creditors with matching names. In some embodiments, the search of the master creditor database makes use of various techniques known to those skilled in the art to find inexact, but possibly matching creditors, e.g., if the name of the creditor is abbreviated or slightly misspelled, or searching trade names as well as legal names. The user/debtor is then presented with a list of zero or more creditors representing possible matches to the name of the creditor submitted by the user. The user is then prompted to select one of the presented choices as the correct creditor or to indicate that no presented choice is correct and then provide further address details for the creditor. Those provided address details are stored in the master creditor database. In some embodiments, a user is provided the option to return later to provide additional address details.

Still referring to FIG. 2B, at 218, method 200 includes notifying the creditor via electronic or physical cease notices that the debtor is in a pre-bankruptcy period or has pre-bankruptcy status. At 220, the creditor is proactively notified, i.e., debtor initiates contact with creditor, via its contact information that the debtor is in a pre-bankruptcy period. In some embodiments, the creditor's contact information is a mailing address and contacting the creditor of the debtor includes generating a hard-copy letter including information related to the debtor stored in the master debtor database and mailing the letter to the creditor. In some embodiments, the contact information is an e-mail address and contacting the creditor includes generating an e-mail including information related to the debtor stored in the master debtor database and transmitting the email to the creditor.

Alternatively, in some embodiments of method 200, step 218 includes first generating a list from the master creditor database for which there is no record of an existing notification or confirmed notification of the pre-bankruptcy status of related debtors in the master debtor database. Then, each creditor-debtor pair is analyzed and details of the communication preferences and capabilities of the creditor are obtained. Next, if the creditor is capable of receiving electronic notices, the details of the creditors available and preferred electronic communication mechanism is retrieved from the database including the information required to deliver the cease notice electronically, either interactively or in batched transmission, via one of a plurality of supported protocols including teletype, facsimile transmission, or transmission in any format over any telecommunication or computer network. Then, according to the instructions in one or more subroutines or subprograms, a properly-formatted electronic cease notice based on the information provided by the debtor is transmitted. Subsequent to the generation and delivery of the cease notices, the master debtor database is updated with the details of the cease notice delivery as well as any response data received.

Still referring to FIG. 2B, in some embodiments, at 222, notifying the creditor in method 200 includes responding to contact from the creditor by providing the creditor with the unique identifying code of the debtor to allow them to access the debtor record stored in the master debtor database to confirm the debtor is in a pre-bankruptcy period.

In practice, the step of notifying the creditor is typically preceded by a direct interaction between a debtor and a creditor in which the debtor declares their representation by counsel and intent to declare bankruptcy. First, a debtor provides its verification code to the creditor. The creditor then connects to the central server. In some embodiments, this connection is accomplished using a telephone connecting to a telephonic interface to the central server. In other embodiments, the connection is performed through a web site interface to the central server. In some embodiments, the connection is based on a variety of machine-to-machine communication mechanisms, either in batch or interactively. In some, when using selected communication mechanisms, the credentials of the creditor are verified.

The creditor then submits the verification code, which was provided by the debtor. In some embodiments, the verification code may be submitted in conjunction with additional data typically held by a creditor. The master debtor database is then searched for a debtor record associated with the verification code. If an associated debtor is found, a response containing relevant details of the debtor's pre-bankrupt status is sent to the creditor, the format and specific contents of which may vary according to the embodiment or communication mechanism. The details of the creditor verification event are then recorded in the master debtor database. If supported by an active interface or communication mechanism, and if the creditor received a plurality of debtor identifiers prior to initiating, the creditor can repeat the process of validating and confirming pre-bankrupt status of the debtor.

In some embodiments, method 200 further comprises receiving confirmation that the creditor received notice that the debtor is in a pre-bankruptcy period.

The systems and methods described herein may be implemented in software or a combination of software and human implemented procedures in some embodiments. In some embodiments, the software includes computer executable instructions stored on computer readable media such as memory or other type of storage devices. Further, such functions correspond to application modules, which are software stored on storage devices, hardware, firmware or any combination thereof. Multiple functions are typically performed in one or more modules as desired, and the embodiments described are merely examples. The software is typically executed on a digital signal processor, ASIC, microprocessor, cloud based system, tablet, smart phone, mobile computing device, or other type of processor operating on a computer system, such as a personal computer, server or other computer system.

Although not illustrated, some embodiments include a computer system to implement the described methods according to an example embodiment. In some embodiments, a hardware and operating environment is provided that is applicable to any of the servers and clients shown in the other figures. In some embodiments, the computer system is part of a cloud computing environment.

Some embodiments of the hardware and operating environment include a general purpose computing device in the form of a computer, e.g., a personal computer, workstation, or server, including one or more processing units, system memory, and a system bus that operatively couples various system components including the system memory to the processing unit. In some embodiments, there are one or more processing units, e.g., in some embodiments, the processor of the computer comprises a single central-processing unit (CPU), or a plurality of processing units, commonly referred to as a multiprocessor or parallel-processor environment. In various embodiments, the computer is a conventional computer, a distributed computer, or any other type of computer.

The system bus is one of several types of bus structures including a memory bus or memory controller, a peripheral bus, and a local bus using any of a variety of bus architectures. In some embodiments, the system memory is referred to as simply the memory, and, in some embodiments, includes read-only memory (ROM) and random-access memory (RAM). In some embodiments, a basic input/output system (BIOS) program, containing the basic routines that help to transfer information between elements within the computer, such as during start-up, is stored in ROM. The computer further includes a hard disk drive for reading from and writing to a hard disk, not shown, a magnetic disk drive for reading from or writing to a removable magnetic disk, and an optical disk drive for reading from or writing to a removable optical disk such as a CD ROM or other optical media.

Hard disk drive, magnetic disk drive, and optical disk drive couple with a hard disk drive interface, a magnetic disk drive interface, and an optical disk drive interface, respectively. The drives and their associated computer-readable media provide non-volatile storage of computer-readable instructions, data structures, program modules and other data for computer. It should be appreciated by those skilled in the art that any type of computer-readable media, which can store data that is accessible by a computer, i.e., magnetic cassettes, flash memory cards, digital video disks, Bernoulli cartridges, random access memories (RAMs), read only memories (ROMs), redundant arrays of independent disks, e.g., RAID storage devices and the like, can be used in the exemplary operating environment.

In some embodiments, a plurality of program modules, e.g., application modules, are stored on the hard disk, magnetic disk, optical disk, ROM, or RAM, including an operating system, one or more application programs, other program modules, and program data. Programming instructions for implementing one or more processes or methods described herein are typically resident on any one or number of these computer-readable media.

In some embodiments, a user enters commands and information into the computer through input devices such as a keyboard and pointing device. Other possible input devices (not shown) include a microphone, joystick, game pad, satellite dish, scanner, or the like. These other input devices are often connected to the processing unit(s) through a serial port interface that is coupled to the system bus, but can be connected by other interfaces, such as a parallel port, game port, or a universal serial bus (USB). A monitor or other type of display device, including a touch screen type device that also provides for user input, can also be connected to the system bus via an interface, such as a video adapter. The monitor displays a graphical user interface for the user. In addition to the monitor, computers typically include other peripheral output devices (not shown), such as speakers and printers.

In some embodiments, a computer operates in a networked environment using logical connections to one or more remote computers or servers. These logical connections are achieved by a communication device coupled to or a part of the computer. Embodiments of the disclosed subject matter are not limited to a particular type of communications device. A remote computer can be another computer, a server, a router, a network PC, a client, a peer device or other common network node, and typically includes many or all of the elements described above relative to computer. In some embodiment, logical connections include a local area network (LAN) and/or a wide area network (WAN). Such networking environments are commonplace in office networks, enterprise-wide computer networks, intranets and the internet, which are all types of networks.

When used in a LAN-networking environment, the computer is connected to the LAN through a network interface or adapter, which is one type of communications device. In some embodiments, when used in a WAN-networking environment, the computer typically includes a modem (another type of communications device) or any other type of communications device, e.g., a wireless transceiver, for establishing communications over the wide-area network, such as the Internet. The modem, which may be internal or external, is connected to the system bus via serial port interface. In a networked environment, program modules depicted relative to the computer are stored in remote memory storage device of the remote computer, or server. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method for notifying a creditor that a pre-bankruptcy period has commenced for a debtor, said method comprising:
detecting and validating an authorized attorney by comparing access data to attorney data stored in a master attorney database that resides on a central server;
capturing debtor data for a debtor from said authorized attorney and storing said debtor data in a debtor record in a master debtor database that resides on said central server, said debtor record being associated with said authorized attorney;
generating a unique identifying code for said debtor and associating said unique identifying code with said debtor record of said debtor;
providing said unique identifying code to at least one of said authorized attorney and said debtor;
entering said unique identifying code via a user interface to access a master creditor database residing on said central server;
searching said master creditor database for data related to a creditor of said debtor;
retrieving contact information of said creditor of said debtor from said master creditor database;
entering data related to said creditor of said debtor into said master creditor database; and
notifying said creditor via said contact information that said debtor is in a pre-bankruptcy period.

2. A method according to claim 1, wherein said access data includes at least one of user credentials, an access method, and an originating network location.

3. A method according to claim 1, wherein said unique identifying code is unique to a relationship between said debtor and said authorized attorney.

4. A method according to claim 1, wherein entering data related to said creditor further comprises entering creditor contact information.

5. A method according to claim 1, wherein entering data related to said creditor further comprises collecting an account number of said creditor of said debtor and storing a name of said creditor and said account number of said creditor in said debtor record in said master debtor database.

6. A method according to claim 1, wherein notifying said creditor includes contacting said creditor of said debtor via said contact information.

7. A method according to claim 6, wherein said contact information is a mailing address and contacting said creditor comprises:
generating a hard-copy letter including information related to said debtor stored in said master debtor database; and
mailing said letter to said creditor.

8. A method according to claim 6, wherein said contact information is an e-mail address and contacting said creditor comprises:
generating an e-mail including information related to said debtor stored in said master debtor database; and
transmitting said email to said creditor.

9. A method according to claim 1, wherein notifying said creditor includes responding to contact from said creditor by providing said creditor with said unique identifying code of said debtor to allow them to access said debtor record stored in said master debtor database to confirm said debtor is in a pre-bankruptcy period.

10. A method according to claim 1, further comprising receiving confirmation that said creditor received notice that said debtor is in a pre-bankruptcy period.

11. A system for notifying a creditor that a pre-bankruptcy period has commenced for a debtor, said system comprising:
a central server including a central processing unit, application modules, a jurisdictional business rules and response formats database, a master creditor database, a master attorney database, and a master debtor database, said central processing unit being configured to store and process data according to particular instructions included in said application modules;
an authorized attorney web client in communication with said central server;
a debtor web client in communication with said central server; and
at least one of a creditor web client, creditor phone client, and creditor server in communication with said central server;
wherein said application modules include a debtor identifying code module, a creditor data module, a creditor notification module, and a creditor access module, all of which cooperate to create a unique identifying code for a debtor, identify a creditor of said debtor, and notify said creditor of said debtor that said debtor is in a pre-bankruptcy period.

12. A system according to claim 11, wherein said debtor identifying code module includes instructions comprising:
detecting and validating an authorized attorney by comparing access data to attorney data stored in said master attorney database that resides on said central server;
capturing debtor data for said debtor from said authorized attorney and storing said debtor data in a debtor record in said master debtor database that resides on said central server, said debtor record being associated with said authorized attorney;
generating said unique identifying code for said debtor and associating said unique identifying code with said debtor record of said debtor; and
providing said unique identifying code to at least one of said authorized attorney and said debtor.

13. A system according to claim 11, wherein said debtor creditor data module includes instructions comprising:
entering said unique identifying code via a user interface to access said master creditor database residing on said central server;
searching said master creditor database for data related to said creditor of said debtor;
retrieving contact information of said creditor of said debtor from said master creditor database; and
entering data related to said creditor of said debtor into said master creditor database.

14. A system according to claim 13, wherein entering data related to said creditor further comprises entering creditor contact information.

15. A system according to claim 13, wherein entering data related to said creditor further comprises collecting an account number of said creditor of said debtor and storing a name of said creditor and said account number of said creditor in said debtor record in said master debtor database.

16. A system according to claim 11, wherein said debtor creditor notification module includes instructions comprising:
contacting said creditor of said debtor via creditor contact information stored on said master creditor database;
wherein said contact information is a mailing address and contacting said creditor comprises generating a hard-copy letter including information related to said debtor stored in said master debtor database; and
mailing said letter to said creditor.

17. A system according to claim 11, wherein said debtor creditor notification module includes instructions comprising:
contacting said creditor of said debtor via creditor contact information stored on said master creditor database;
wherein said contact information is an e-mail address and contacting said creditor comprises generating an e-mail including information related to said debtor stored in said master debtor database; and
transmitting said email to said creditor.

18. A system according to claim 11, wherein said creditor access module includes instructions comprising responding to contact from said creditor by providing said creditor with said unique identifying code of said debtor to allow them to access said debtor record stored in said master debtor database to confirm said debtor is in a pre-bankruptcy period.

19. A method for notifying a creditor that a pre-bankruptcy period has commenced for a debtor, said method comprising:
validating an authorized attorney by comparing access data to attorney data stored in a master attorney database that resides on a central server;
capturing debtor data for a debtor from said authorized attorney and storing said debtor data in a debtor record in a master debtor database that resides on said central server, said debtor record being associated with said authorized attorney;
generating a unique identifying code for said debtor and associating said unique identifying code with said debtor record of said debtor;
providing said unique identifying code to at least one of said authorized attorney and said debtor;
entering said unique identifying code via a user interface to access a master creditor database residing on said central server;
searching said master creditor database for data related to a creditor of said debtor;
retrieving contact information of said creditor of said debtor from said master creditor database;
notifying said creditor via said contact information that said debtor is in a pre-bankruptcy period; and
receiving confirmation that said creditor received notice that said debtor is in a pre-bankruptcy period.

20. A method according to claim 19, wherein notifying said creditor further comprises at least one of (1) generating a hard-copy letter including information related to said debtor stored in said master debtor database and mailing said letter to said creditor; and (2) generating an e-mail including information related to said debtor stored in said master debtor database and transmitting said email to said creditor.
